(19) United States
(12) Patent Application Publication
(10) Pub. No.: US 2025/0315729 A1
(43) Pub. Date: Oct. 9, 2025

(54) SYSTEMS AND METHODS FOR ASSESSING MACHINE LEARNING MODEL PERFORMANCE

(71) Applicant: ServiceNow, Inc., Santa Clara, CA (US)

(72) Inventors: Sayedmasoud Hashemi Amroabadi, Toronto (CA); Fabio Casati, Zurich (CH); Sagar Davasam Suryanarayan, Santa Clara, CA (US); Gopal Sarda, Union City, CA (US); Louis Philip Morin, Laval, Quebec (CA); Marc-Etienne Prosen Brunet, Ottawa, Ontario (CA)

(21) Appl. No.: 19/081,499

(22) Filed: Mar. 17, 2025

Related U.S. Application Data
(60) Provisional application No. 63/631,810, filed on Apr. 9, 2024.

(51) Int. Cl. G06N 20/00; G06F 11/34

(52) U.S. Cl. CPC G06N 20/00; G06F 11/3419

(57) ABSTRACT

A method includes receiving an input requesting an output from a machine learning (ML) model, identifying a feature space for the output, wherein the feature space is associated with one or more shared characteristics shared by the output and one or more additional outputs of the ML model, determining a feature space proficiency metric for the ML model in the identified feature space, and in response to the feature space proficiency metric for the ML model in the identified feature space satisfying an error threshold, providing the input to an alternative resource configured to generate the output.

### CROSS-REFERENCE TO RELATED APPLICATIONS

This application claims priority to and benefit of Provisional Application No. 63/631,810, entitled “SYSTEMS AND METHODS FOR ASSESSING MACHINE LEARNING MODEL PERFORMANCE” and filed on Apr. 9, 2024, which is herein incorporated by reference in its entirety for all purposes.

### TECHNICAL FIELD

The present disclosure relates generally to machine learning (ML) models. Specifically, the present disclosure relates to assessing and improving ML model performance.

### BACKGROUND

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Organizations, regardless of size, rely upon access to information technology (IT) and data and services for their continued operation and success. A respective organization's IT infrastructure may have associated hardware resources (e.g., computing devices, load balancers, firewalls, switches, etc.) and software resources (e.g., productivity software, database applications, custom applications, and so forth). Over time, more and more organizations have turned to cloud computing approaches to supplement or enhance their IT infrastructure solutions.

Cloud computing relates to the sharing of computing resources that are generally accessed via the Internet. In particular, a cloud computing infrastructure allows users, such as individuals and/or enterprises, to access a shared pool of computing resources, such as servers, storage devices, networks, applications, and/or other computing-based services. By doing so, users are able to access computing resources on demand that are located at remote locations and such resources may be used to perform a variety computing functions (e.g., storing and/or processing large quantities of computing data).

For enterprise and other organization users, cloud computing provides flexibility in resources utilized and/or provided by the enterprise. For example, cloud computing infrastructure may be utilized to provide access to one or more ML models. During training of a ML model, and run-time operation of a corresponding trained ML model, observability of the untrained and trained ML models is limited. Accordingly, it can be difficult to assess whether a ML model is generating accurate (e.g., expected, non-hallucinating) outputs based on received inputs. Further, it can be difficult to distinguish between a task for which a model generates accurate outputs, and a different task for which the model does not generate accurate outputs. Difficulty in assessing the performance of a ML model reduces the effectiveness in updating the ML model, and may result in inefficient usage of computing resources.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

Various embodiments disclosed herein are directed to techniques for analyzing and improving performance of machine learning models. System logs, feedback data (e.g., generated by users, agents, or other ML models in response to an output of the ML model), and other data may be used to calculate one or more metrics for each output generated. For example, for each output generated, the metrics may include determining the accuracy of the output and the coverage of the output. In some embodiments, the accuracy and coverage of a particular output may be combined and compared relative to a credibility interval.

A failure analysis is performed for the outputs that are outside of the credibility interval or otherwise have accuracy and/or coverage metrics below threshold values (e.g., outputs determined to be incorrect, inappropriate, or otherwise undesireable). The failure analysis may include clustering input/output exchanges based on shared characteristics. For example, each input/output exchange may be assigned a value (e.g., a point, category, increment, score, rating, etc.) in one or more dimensions that correspond to characteristics or properties of the input/output exchange. Dimensions may include, for example, format of input, language of input and/or output, input structure, user sentiment, subject matter, task to be performed, and so forth. Dimensions may be continuous or discrete such that a point within a dimension may be a point along a continuous spectrum or one of multiple discrete or quantized options. Input/output exchanges with shared or similar points in a common dimension may be grouped into clusters that fall into feature spaces. How well a ML model performs within a feature space can be determined based on the metrics for the input/output exchanges that fall within the feature space. Accordingly, the feature spaces in which a ML model performs below a target performance level can be identified and new training datasets generated to improve a ML model's performance in those feature spaces.

In run time, an input may be received requesting an output from a ML model. The input may be analyzed by performing a feature space membership analysis to determine one or more feature spaces in which the input and/or the requested output fall. The feature space membership analysis may include, for example, identifying a respective point for the input or output within one or more dimensions. If the input or output falls within a feature space for which the ML model performs above or equal to a threshold, the input may be provided to the ML model and an output generated by the ML model. If the input or output falls within a feature space for which the ML model performs below a threshold, the input may be deflected away from the ML model (e.g., to an alternative ML model or a non-ML resource for generating the output). Alternatively, if the input falls within a feature space for which the ML model performs below a threshold, the input may be transformed to a transformed input within a feature space for which the ML model performs above a threshold. The transformed input may then be provided to the ML model and an output generated by the ML model.

In an embodiment, a method includes accessing a dataset representative of a plurality of operations of a machine learning (ML) model, wherein each of the plurality of operations includes a respective input to the ML model, a respective output generated by the ML model, and a respective performance metric characterizing the respective output, identifying a subset of the plurality of operations based on a determination that the subset of the plurality of operations satisfies a similarity criterion, clustering the subset of the plurality of operations into a cluster, defining a feature space based on the cluster, and determining a feature space proficiency metric of the ML model in the feature space based on the respective performance metrics characterizing the subset of the plurality of operations in the cluster.

In another embodiment, a method includes identifying a feature space for which a machine learning (ML) model has a feature space proficiency metric below a threshold feature space proficiency metric, wherein the feature space is defined by two or more operations in which the ML model generated two or more respective outputs, wherein the two or more operations have at least one characteristic in common, generating a training dataset configured to increase the feature space proficiency metric of the ML model above the threshold feature space proficiency metric, wherein the training dataset comprises data points associated with the feature space, and training the ML model based on the generated training dataset.

In a further embodiment, a method includes receiving an input requesting an output from a machine learning (ML) model, identifying a feature space for the output, wherein the feature space is associated with one or more shared characteristics shared by the output and one or more additional outputs of the ML model, determining a feature space proficiency metric for the ML model in the identified feature space, and in response to the feature space proficiency metric for the ML model in the identified feature space satisfying an error threshold, providing the input to an alternative resource configured to generate the output.

Various refinements of the features noted above may exist in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a block diagram of an embodiment of a multi-instance cloud architecture in which embodiments of the present techniques may operate;

FIG. 2 is a schematic diagram of an embodiment of a multi-instance cloud architecture in which embodiments of the present techniques may operate;

FIG. 3 is a block diagram of a computing device utilized in a computing system that may be present in FIG. 1 or 2, in accordance with aspects of the present techniques;

FIG. 4 is a block diagram illustrating an embodiment in which a virtual server supports and enables a client instance that operates one or more machine learning (ML) models, in accordance with aspects of the present techniques;

FIG. 5 illustrates a development framework and a runtime framework for the ML model of FIG. 4, in accordance with aspects of the present techniques;

FIG. 6 illustrates a framework for improving performance of the ML model of FIG. 4, in accordance with aspects of the present techniques;

FIG. 7 illustrates a framework for assessing and improving the ML model of FIG. 4, in accordance with aspects of the present techniques;

FIG. 8 is a schematic illustrating an autonomous LLM pipeline, which may be applied to the ML model of FIG. 4, in accordance with aspects of the present techniques;

FIG. 9 is a flow chart of a process for assessing the performance of the ML model of FIG. 4, in accordance with aspects of the present techniques;

FIG. 10 is a flow chart of a process for improving the ML model of FIG. 4, in accordance with aspects of the present techniques; and

FIG. 11 is a flow chart of a process for utilizing the ML model of FIG. 4 in runtime, in accordance with aspects of the present techniques.

### DETAILED DESCRIPTION

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and enterprise-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

As used herein, the term “computing system” refers to an electronic computing device such as, but not limited to, a single computer, virtual machine, virtual container, host, server, laptop, and/or mobile device, or to a plurality of electronic computing devices working together to perform the function(s) described as being performed on or by the computing system. As used herein, the term “medium” or “computer-readable medium” refers to one or more non-transitory, computer-readable physical media that together store the contents described as being stored thereon. Embodiments may include non-volatile secondary storage, read-only memory (ROM), and/or random-access memory (RAM). As used herein, the term “application” refers to one or more computing modules, programs, processes, workloads, threads and/or a set of computing instructions executed by a computing system. Example embodiments of an application include software modules, software objects, software instances and/or other types of executable code.

Cloud computing infrastructure may be used to host one or more ML models. During training of a ML model, and run-time operation of a corresponding trained ML model, observability of the untrained and trained ML models is limited. Accordingly, it can be difficult to assess whether a ML model is generating accurate (e.g., expected, non-hallucinating) outputs based on the inputs. Further, it can be difficult to distinguish between a task for which a model generates accurate outputs, and a different task for which the model does not generate accurate outputs. Difficulty in assessing the performance of a ML model reduces the effectiveness in updating the ML model, and may result in inefficient usage of computing resources, poor performance of AI/ML models, slow improvement of AI/ML models, reliance on inaccurate AI/ML model outputs, slow adoption of AI/ML models, and so forth.

Accordingly, the presently disclosed techniques may be used for analyzing and improving performance of machine learning models. System logs, feedback data (e.g., generated by users, agents, or other ML models in response to an output of the ML model), and other data may be used to calculate one or more metrics for each output generated. For example, for each output generated, the metrics may include determining the accuracy of the output and the coverage of the output. In some embodiments, the accuracy and coverage of a particular output may be combined and compared relative to a credibility interval.

A failure analysis is performed for the outputs that are outside of the credibility interval, have accuracy and/or coverage metrics below threshold values, or are otherwise determined to be undesirable. The failure analysis may include clustering input/output exchanges based on shared characteristics. For example, each input/output exchange may be assigned a point in one or more dimensions that correspond to characteristics or properties of the input/output exchange. Dimensions may include, for example, format of input, language of input and/or output, input structure, user sentiment, subject matter, task to be performed, and so forth. Dimensions may be continuous or discrete such that a point within a dimension may be a point along a continuous spectrum or one of multiple discrete or quantized options. In some embodiments, inputs and/or outputs may be mapped to a point in multidimensional space that includes at least two of the one or more dimensions, such that each dimension is a characteristic of interest (e.g., is the input in the form of an email or a chat message?). Input/output exchanges with shared or similar points in a common dimension may be grouped into clusters that fall into feature spaces. How well a ML model performs within a feature space can be determined based on the metrics for the input/output exchanges that fall within the feature space. Accordingly, the feature spaces in which a ML model performs below a target performance level can be identified and new training datasets generated to improve a ML model's performance in those feature spaces. Being able to identify feature spaces in which a ML model performs below a target level allows for training data to be narrowly targeted to deficient feature spaces such that resources utilized to improve the ML model are efficiently utilized to improve the performance of the ML model in feature spaces for which improvement is needed most. Previously, training data of broad scope was collected and used to train ML models in hopes that the training data would improve performance of the ML model across the board.

In run time, an input may be received requesting an output from a ML model. The input may be analyzed by performing a feature space membership analysis to determine one or more feature spaces in which the input and/or the requested output fall. The feature space membership analysis may include, for example, identifying a respective point for the input or output within one or more dimensions. If the input or output falls within a feature space for which the ML model performs above or equal to a threshold, the input may be provided to the ML model and an output generated by the ML model. If the input or output falls within a feature space for which the ML model performs below a threshold, the input may be deflected away from the ML model (e.g., to an alternative ML model or a non-ML resource for generating the output). Alternatively, if the input falls within a feature space for which the ML model performs below a threshold, the input may be transformed to a transformed input within a feature space for which the ML model performs above a threshold. The transformed input may then be provided to the ML model and an output generated by the ML model. Previously, inputs were provided to ML models without consideration of whether the input requested that the ML model perform an operation it was not well suited for. By screening inputs received and deflecting inputs requesting operations for which the ML model is not well-suited to alternative resources, overall performance in generating outputs in response to inputs is improved (e.g., outputs are more accurate and more relevant to inputs). The disclosed techniques result in better performing ML models, which improve at a faster rate than was previously possible, resulting in improved confidence in ML models and faster adoption of ML models.

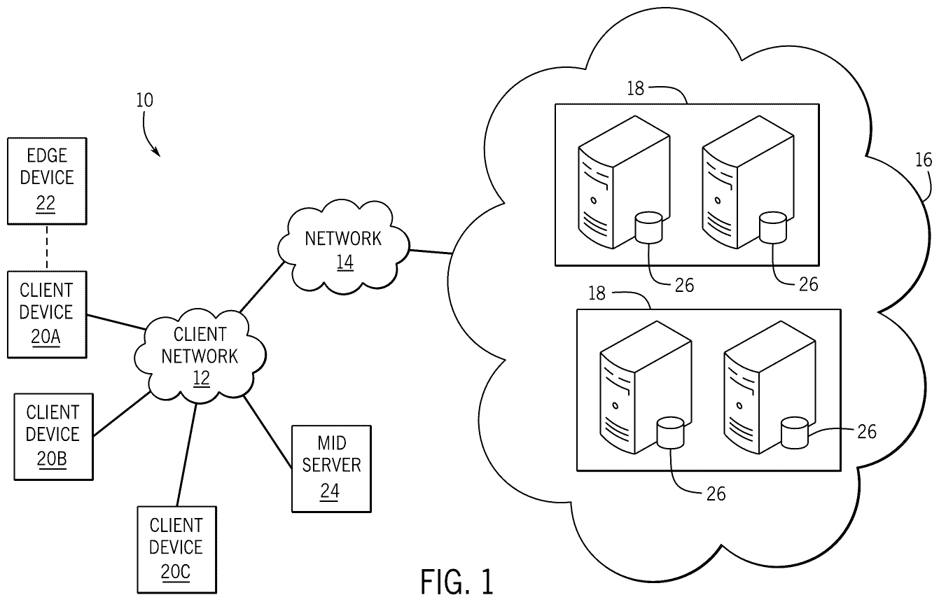

With the preceding in mind, the following figures relate to various types of generalized system architectures or configurations that may be employed to provide services to an organization in a multi-instance framework and on which the present approaches may be employed. Correspondingly, these system and platform examples may also relate to systems and platforms on which the techniques discussed herein may be implemented or otherwise utilized. Turning now to FIG. 1, a schematic diagram of an embodiment of a cloud computing system 10 where embodiments of the present disclosure may operate, is illustrated. The cloud computing system 10 may include a client network 12, a network 14 (e.g., the Internet), and a cloud-based platform 16. In one embodiment, the client network 12 may be a local private network, such as local area network (LAN) having a variety of network devices that include, but are not limited to, switches, servers, and routers. In another embodiment, the client network 12 represents an enterprise network that could include one or more LANs, virtual networks, data centers 18, and/or other remote networks. As shown in FIG. 1, the client network 12 is able to connect to one or more client devices 20A, and 20B so that the client devices are able to communicate with each other and/or with the network hosting the platform 16. The client devices 20 may be computing systems and/or other types of computing devices generally referred to as Internet of Things (IoT) devices that access cloud computing services, for example, via a web browser application or via an edge device 22 that may act as a gateway between the client devices 20 and the platform 16. FIG. 1 also illustrates that the client network 12 includes an administration or managerial device, server, or software-implemented agent, such as a management, instrumentation, and discovery (MID) server 24 that facilitates communication of data between the network hosting the platform 16, other external applications, data sources, and services, and the client network 12. Although not specifically illustrated in FIG. 1, the client network 12 may also include a connecting network device (e.g., a gateway or router) or a combination of devices that implement a customer firewall or intrusion protection system.

For the illustrated embodiment, FIG. 1 illustrates that client network 12 is coupled to the network 14, which may include one or more computing networks, such as other LANs, wide area networks (WAN), the Internet, and/or other remote networks, to transfer data between the client devices 20 and the network hosting the platform 16. Each of the computing networks within network 14 may contain wired and/or wireless programmable devices that operate in the electrical and/or optical domain. For example, network 14 may include wireless networks, such as cellular networks (e.g., Global System for Mobile Communications (GSM) based cellular network), IEEE 802.11 networks, and/or other suitable radio-based networks. The network 14 may also employ any number of network communication protocols, such as Transmission Control Protocol (TCP) and Internet Protocol (IP). Although not explicitly shown in FIG. 1, network 14 may include a variety of network devices, such as servers, routers, network switches, and/or other network hardware devices configured to transport data over the network 14.

In FIG. 1, the network hosting the platform 16 may be a remote network (e.g., a cloud network) that is able to communicate with the client devices 20 via the client network 12 and network 14. The network hosting the platform 16 provides additional computing resources to the client devices 20 and/or the client network 12. For example, by utilizing the network hosting the platform 16, users of the client devices 20 are able to access one or more machine learning (ML) models configured to generate outputs in response to received inputs. In one embodiment, the network hosting the platform 16 is implemented on the one or more data centers 18, where each data center could correspond to a different geographic location. Each of the data centers 18 includes a plurality of virtual servers 26 (also referred to as application nodes, application servers, virtual server instances, application instances, or application server instances), where one or more virtual servers 26 can be implemented on a physical computing system, such as a single electronic computing device (e.g., a single physical hardware server) or across multiple-computing devices (e.g., multiple physical hardware servers). Examples of virtual servers 26 include, but are not limited to a web server (e.g., a unitary Apache installation), an application server (e.g., unitary JAVA Virtual Machine), and/or a database server (e.g., a unitary relational database management system (RDBMS) catalog).

To utilize computing resources within the platform 16, network operators may choose to configure the data centers 18 using a variety of computing infrastructures. In one embodiment, one or more of the data centers 18 are configured using a multi-tenant cloud architecture, such that one of the server instances 26 handles requests from and serves multiple customers. Data centers 18 with multi-tenant cloud architecture commingle and store data from multiple customers, where multiple customer instances are assigned to one of the virtual servers 26. In a multi-tenant cloud architecture, the particular virtual server 26 distinguishes between and segregates data and other information of the various customers. For example, a multi-tenant cloud architecture could assign a particular identifier for each customer in order to identify and segregate the data from each customer. Generally, implementing a multi-tenant cloud architecture may suffer from various drawbacks, such as a failure of a particular one of the server instances 26 causing outages for all customers allocated to the particular server instance.

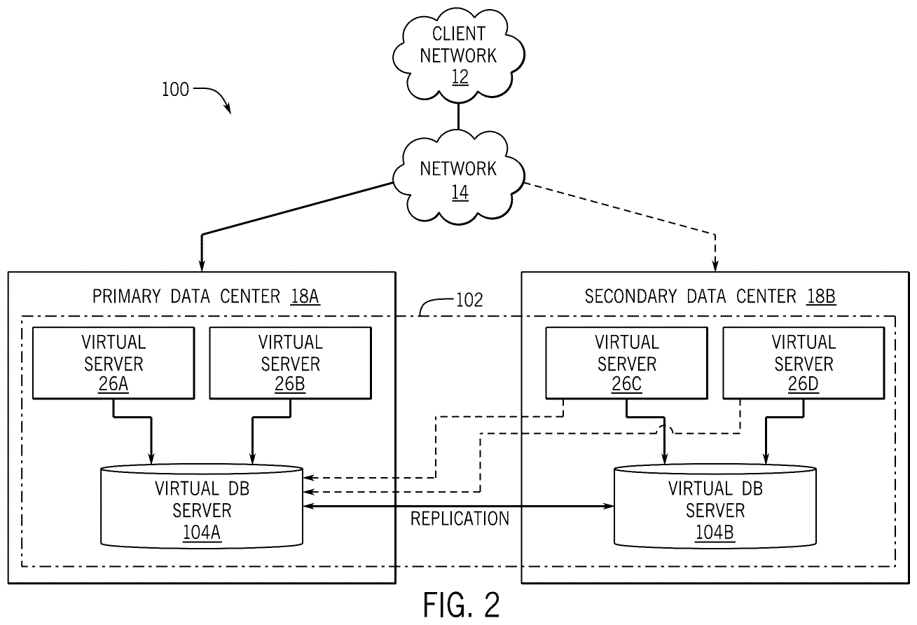

In another embodiment, one or more of the data centers 18 are configured using a multi-instance cloud architecture to provide every customer its own unique customer instance or instances. For example, a multi-instance cloud architecture could provide each customer instance with its own dedicated application server and dedicated database server. In other examples, the multi-instance cloud architecture could deploy a single physical or virtual server 26 and/or other combinations of physical and/or virtual servers 26, such as one or more dedicated web servers, one or more dedicated application servers, and one or more database servers, for each customer instance. In a multi-instance cloud architecture, multiple customer instances could be installed on one or more respective hardware servers, where each customer instance is allocated certain portions of the physical server resources, such as computing memory, storage, and processing power. By doing so, each customer instance has its own unique software stack that provides the benefit of data isolation, relatively less downtime for customers to access the platform 16, and customer-driven upgrade schedules. An example of implementing a customer instance within a multi-instance cloud architecture will be discussed in more detail below with reference to FIG. 2.

FIG. 2 is a schematic diagram of an embodiment of a multi-instance cloud architecture 100 where embodiments of the present disclosure may operate. FIG. 2 illustrates that the multi-instance cloud architecture 100 includes the client network 12 and the network 14 that connect to two (e.g., paired) data centers 18A and 18B that may be geographically separated from one another. Using FIG. 2 as an example, network environment and service provider cloud infrastructure client instance 102 (also referred to herein as a client instance 102) is associated with (e.g., supported and enabled by) dedicated virtual servers (e.g., virtual servers 26A, 26B, 26C, and 26D) and dedicated database servers (e.g., virtual database servers 104A and 104B). Stated another way, the virtual servers 26A-26D and virtual database servers 104A and 104B are not shared with other client instances and are specific to the respective client instance 102. In the depicted example, to facilitate availability of the client instance 102, the virtual servers 26A-26D and virtual database servers 104A and 104B are allocated to two different data centers 18A and 18B so that one of the data centers 18 acts as a backup data center. Other embodiments of the multi-instance cloud architecture 100 could include other types of dedicated virtual servers, such as a web server. For example, the client instance 102 could be associated with (e.g., supported and enabled by) the dedicated virtual servers 26A-26D, dedicated virtual database servers 104A and 104B, and additional dedicated virtual web servers (not shown in FIG. 2).

Although FIGS. 1 and 2 illustrate specific embodiments of a cloud computing system 10 and a multi-instance cloud architecture 100, respectively, the disclosure is not limited to the specific embodiments illustrated in FIGS. 1 and 2. For instance, although FIG. 1 illustrates that the platform 16 is implemented using data centers, other embodiments of the platform 16 are not limited to data centers and can utilize other types of remote network infrastructures. Moreover, other embodiments of the present disclosure may combine one or more different virtual servers into a single virtual server or, conversely, perform operations attributed to a single virtual server using multiple virtual servers. For instance, using FIG. 2 as an example, the virtual servers 26A, 26B, 26C, 26D and virtual database servers 104A, 104B may be combined into a single virtual server. Moreover, the present approaches may be implemented in other architectures or configurations, including, but not limited to, multi-tenant architectures, generalized client/server implementations, and/or even on a single physical processor-based device configured to perform some or all of the operations discussed herein. Similarly, though virtual servers or machines may be referenced to facilitate discussion of an implementation, physical servers may instead be employed as appropriate. The use and discussion of FIGS. 1 and 2 are only examples to facilitate ease of description and explanation and are not intended to limit the disclosure to the specific examples illustrated therein.

As may be appreciated, the respective architectures and frameworks discussed with respect to FIGS. 1 and 2 incorporate computing systems of various types (e.g., servers, workstations, client devices, laptops, tablet computers, cellular telephones, and so forth) throughout. For the sake of completeness, a brief, high level overview of components typically found in such systems is provided. As may be appreciated, the present overview is intended to merely provide a high-level, generalized view of components typical in such computing systems and should not be viewed as limiting in terms of components discussed or omitted from discussion.

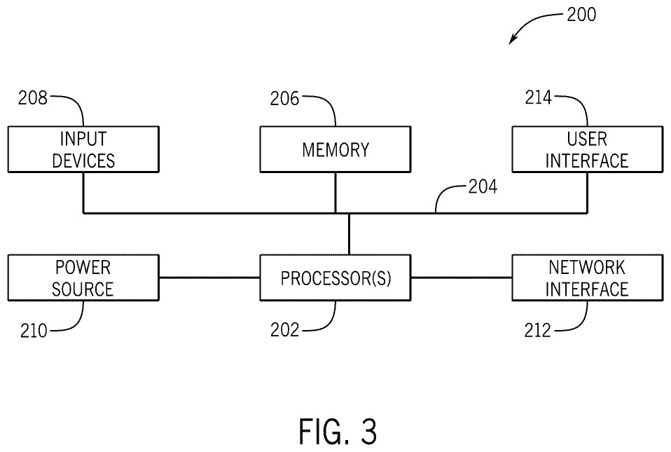

By way of background, it may be appreciated that the present approach may be implemented using one or more processor-based systems such as shown in FIG. 3. Likewise, applications and/or databases utilized in the present approach may be stored, employed, and/or maintained on such processor-based systems. As may be appreciated, such systems as shown in FIG. 3 may be present in a distributed computing environment, a networked environment, or other multi-computer platform or architecture. Likewise, systems such as that shown in FIG. 3, may be used in supporting or communicating with one or more virtual environments or computational instances on which the present approach may be implemented.

With this in mind, an example computer system may include some or all of the computer components depicted in FIG. 3. FIG. 3 generally illustrates a block diagram of example components of a computing system 200 and their potential interconnections or communication paths, such as along one or more busses. As illustrated, the computing system 200 may include various hardware components such as, but not limited to, one or more processors 202, one or more busses 204, memory 206, input devices 208, a power source 210, a network interface 212, a user interface 214, and/or other computer components useful in performing the functions described herein.

The one or more processors 202 may include one or more microprocessors capable of performing instructions stored in the memory 206. Additionally or alternatively, the one or more processors 202 may include application-specific integrated circuits (ASICs), field-programmable gate arrays (FPGAs), and/or other devices designed to perform some or all of the functions discussed herein without calling instructions from the memory 206.

With respect to other components, the one or more busses 204 include suitable electrical channels to provide data and/or power between the various components of the computing system 200. The memory 206 may include any tangible, non-transitory, and computer-readable storage media. Although shown as a single block in FIG. 1, the memory 206 can be implemented using multiple physical units of the same or different types in one or more physical locations. The input devices 208 correspond to structures to input data and/or commands to the one or more processors 202. For example, the input devices 208 may include a mouse, touchpad, touchscreen, keyboard and the like. The power source 210 can be any suitable source for power of the various components of the computing device 200, such as line power and/or a battery source. The network interface 212 includes one or more transceivers capable of communicating with other devices over one or more networks (e.g., a communication channel). The network interface 212 may provide a wired network interface or a wireless network interface. A user interface 214 may include a display that is configured to display text or images transferred to it from the one or more processors 202. In addition to and/or alternative to the display, the user interface 214 may include other devices for interfacing with a user, such as lights (e.g., LEDs), speakers, and the like.

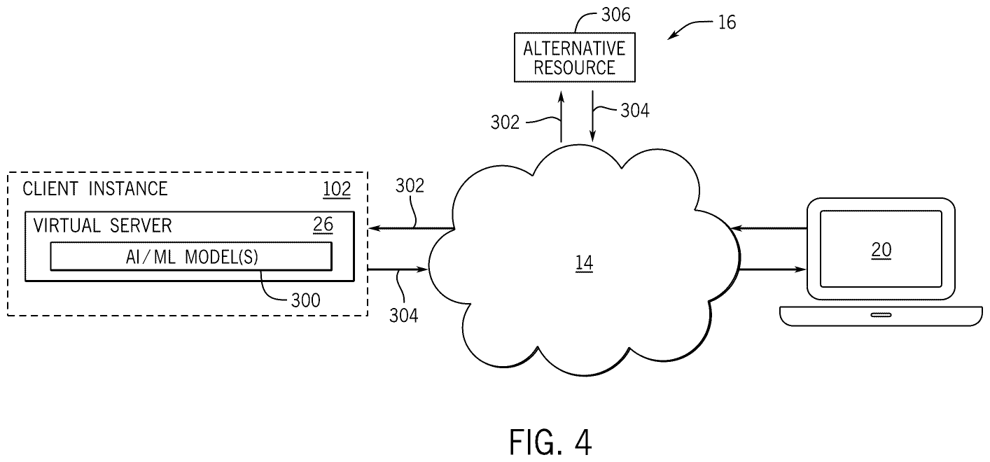

With the preceding in mind, FIG. 4 is a block diagram illustrating an embodiment in which a virtual server 26 supports and enables the client instance 102, according to one or more disclosed embodiments. More specifically, FIG. 4 illustrates an example of a portion of a service provider cloud infrastructure, including the cloud-based platform 16 discussed above. The cloud-based platform 16 is connected to one or more client devices 20 via the network 14 to provide a user interface to one or more ML models 300 within the client instance 102 (e.g., via a web browser of the client device 20). Client instance 102 is supported by virtual servers 26 similar to those explained with respect to FIG. 2, and is illustrated here to show support for the disclosed functionality described herein within the client instance 102. The client instance 102 may be configured to receive one or more inputs 302 from the client device 20 (e.g., via the network 14), provide the inputs 302 to one or more of the ML models 300 (e.g., an inference model), and provide an output 304 generated by the one or more ML models 300 to the client device 20 (e.g., via the network 14). The inputs 302 may include, for example, one or more prompts, and, in some embodiments, one or more datasets accompanying the one or more prompts. The client instance 102 may also store or otherwise have access to one or more sets of operational data, such as ground truth data (e.g., ground truth labels for one or more properties), feedback data, training data, and so forth that may be used to train or otherwise update the one or more models 300. As discussed above, assessing whether the one or more ML models 300 are generating accurate (e.g., expected, non-hallucinating) outputs can be difficult. Accordingly, in some embodiments, the one or more models 300 may also include an evaluation model configured to assess outputs generated by the inference model and generate an evaluation of the output. The evaluation may consider, for example, the accuracy of the output, the coverage (e.g., relevance) of the output, and so forth, based on the input, and, in some cases, one or more pieces of contextual data (e.g., identifiers) associated with the operation.

In some embodiments, inputs 302 may be analyzed before being provided to one or more ML models 300. In such embodiments, if the input 302 requests that the ML model 300 performs an operation or generates an output 304 for which the ML model 300 may not generate accurate and/or relevant outputs 304, the input may be deflected to an alternative resource (e.g., another ML model, an algorithm, an agent profile, a document or webpage, such as a troubleshooting guide, an article about a particular topic, etc.), and so forth. In such cases, the alternative resource 306 may receive the input 302 and generate the output 304. It should be understood, however, that embodiments are also envisaged in which the disclosed techniques are implemented in non-cloud computing infrastructures. For example, the ML models 300 may be hosted local on an computing device, on an on premises (“on-prem”) server, on a remote server, and so forth.

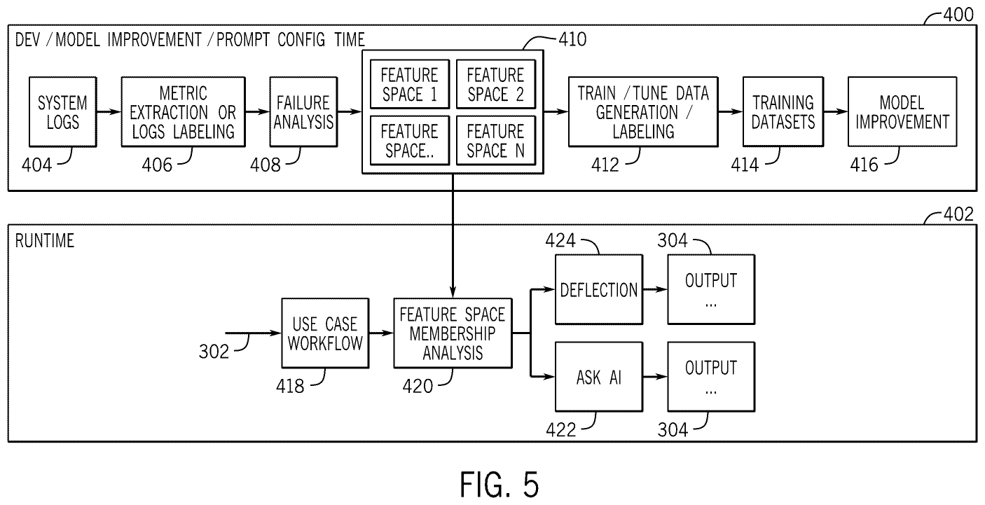

With this in mind, FIG. 5 illustrates a development framework 400 and a runtime framework 402 for a ML model (e.g., one of the ML models 300 of FIG. 4). The system logs 404 may include event logs, server logs, system logs, authorization/access logs, resource logs, availability logs, and so forth. Accordingly, the system logs 404 may include data about inputs received, outputs generated, characteristics of network traffic (e.g., time, content, size, etc.), network events, access to resources, system performance, uptime, downtime, and so forth.

At block 406, data may be pulled from the system logs 404 and labeled, and/or metrics extracted based on data from the system logs 404 and/or other data (e.g., feedback data). In some embodiments, extracting metrics from system logs may include capturing events (e.g., mouse overs, selected hyperlinks, user inputs, submitted tickets, collected events) represented in the system logs, and correlating events with one another, or with other system log data. Metrics may then be determined for ML model operations (e.g., generating an output in response to a received input) based on the events, the system log data, other data (e.g., feedback data), or some combination thereof. For example, if an input to a ML model is received from a client device, an output is generated by the ML model and transmitted back to the client device, and the system logs indicate that the client device later conducted a web search on the same or similar topic, or the client device subsequently submitted a helpdesk ticket related to the input, then it can be assumed that the output generated by the ML model was not helpful in addressing the input.

Metrics may also be determined based on other data outside of the system logs 404. For example, feedback data may include feedback provided by users, agents, the evaluation model, and so forth, indicating whether particular outputs generated by the model were accurate, relevant, helpful, too short, too long, and so forth. Such feedback data may be qualitative (e.g., a text string, an assigned category, a tag, etc., such as “incorrect”, “not accurate”, “too long”, “not relevant”, and so forth), or quantitative (e.g., a score, rating, or binary in one or more parameters, such as accuracy, relevance, length, specificity, and so forth). Accordingly, in some embodiments, processing feedback data may involve applying natural language understanding (NLU) techniques to comments provided by user profiles and/or agent profiles. The feedback data may be generated based on user inputs received from one or more client devices that may be associated with user profiles, agent profiles, and so forth.

The metrics may represent qualitative assessments of one or more aspects of particular operations performed by ML models to generate respective outputs based on received inputs. For example, the metrics may assess particular operations to generate an output based on the accuracy of the output, the coverage (e.g., relevance) of the output, whether the output was helpful, whether the output was too short or too long, etc. In some embodiments, a confidence interval may also be determined to quantify the accuracy of a metric in one or more dimensions. To determine if an output is desirable, metrics and/or confidence intervals across multiple dimensions may be compared to threshold values. In some embodiments, multiple metrics may be combined into one or more combined metrics. For example, a credibility interval may define a range of acceptable outputs based on accuracy and coverage. Accordingly, the credibility interval may define a box on a plot in which the accuracy metric is plotted along a first axis and the coverage metric is plotted along a second axis. If the point on the plot defined by the accuracy metric and the coverage metric falls within the box defined by the credibility interval, the output is determined to be desirable. Correspondingly, if the point on the plot defined by the accuracy metric and the coverage metric falls outside the box defined by the credibility interval, the output is determined to be not desirable.

At block 408, failure analysis is performed. In some embodiments, the failure analysis may be performed only on outputs considered to be not desirable or that otherwise have one or more metrics below some threshold level. However, in other embodiments, the failure analysis may include analysis of outputs considered to be desirable or that otherwise have one or more metrics above some threshold level. Operations by the ML model to generate outputs may be analyzed to identify trends in an attempt to understand why the outputs considered to be not desirable or otherwise have one or more metrics below some threshold level where not desirable or had metrics below the threshold level. Specifically, operations by the ML model to generate outputs that satisfy a similarity criterion (e.g., have one or more characteristics in common) may be grouped into clusters. Accordingly, failure analysis may include identifying one or more dimensions of interest, using the identified dimensions of interest as axes in a hyperspace, mapping each input, output, or input/output combination onto a point in the hyperspace, and grouping points into clusters based on shared characteristics.

During embedding, each operation by the ML model to generate an output may be considered and assigned a point in multiple dimensions. Once dimensions of interest have been identified and inputs/outputs have been mapped to points in the hyperspace defined by the identified dimensions, clustering may be performed, for example, in an unsupervised fashion, in a supervised fashion, based on a hypothesis, based on one or more candidate properties, by applying one or more rules, and so forth. For example, the dimensions may include input structure, user sentiment, application domain, and so forth. Dimensions may be continuous or include multiple discrete options. In some embodiments, the dimensions are human interpretable (e.g., easily understood by a human, such as language of the input), whereas in other embodiments, one or more dimensions may be understandable by a computer or a model, but not easily understood by a human (e.g., word embedding vectors). In some embodiments, an operation by the ML model to generate an output may include partial embeddings such that an operation may be assigned a point in some dimensions, but not others. Further, assignment of an operation by the ML model may be probabilistic such that the point in a particular dimension may include a confidence interval. For example, possible dimensions may include language of the input, structure/format of the input, sentiment of the input, the operation being requested, the format of one or more datasets accompanying the input (e.g., text file, PDF, audio file, image, etc.), format of the output, subject matter of the input, and so forth.

Clustering may be performed in an automated fashion using a different ML model or an algorithm, in a semi-automated fashion in which a hypothesis is proposed and then tested by the model or algorithm, or in a manual fashion in which inputs are provided by a user profile grouping operations by the ML model to generate outputs into particular clusters. In other embodiments, clustering may be performed in some combination of automated, semi-automated, and manual techniques.

In some embodiments, a dimension discovery process may be performed periodically to discover new dimensions that may be applicable to the data. For example, the dimension discovery process may include parsing a dataset, identifying new dimensions in the dataset, and in some cases, identifying whether such new dimensions improve clustering performance. For example, given a model and a set of ground truth data, each candidate new dimension can be evaluated based on a point in error space, where it can be determined with a reasonable probability that the example will be correctly classified by the ML model. Accordingly, an ML model may be provided with on a group of examples, asked to discover dimensions, provided feedback on discovered dimensions, and iterated multiple times to train the ML model to discover dimensions.

Feature spaces 410 may be defined based on the dimensions of interest identified during failure analysis (block 408) along which points are plotted in hyperspace and then clustered. The feature spaces 410 are property-based such that a cluster of operations by the ML model to generate outputs having a property in common (e.g., a point along a particular dimension) share a feature space. Accordingly, all of the operations by the ML model to generate outputs that have the common property (e.g., a point along a particular dimension) of a feature space fall in the feature space and all of the operations by the ML model to generate outputs that do not have the common property (e.g., a point along a particular dimension) of the feature space fall outside of the feature space. It should be understood that because a particular operation by the ML model to generate an output may have multiple properties, that the particular operation by the ML model to generate an output may be associated with multiple feature spaces.

At block 412 data generation is trained and/or tuned and labeling may be performed. Specifically, a ML model's proficiency in a given feature space may be determined based on the metrics of the operations by the ML model to generate an output based on an input associated with the feature space. For example, the ML model's proficiency in the feature space may be determined by performing an average, adjusted average, or some other statistical calculation of the metrics of all of the operations associated with the feature space, all of the operations associated with the feature space since the ML model was last updated/trained, or some other subset of the operations associated with feature space. The ML model's proficiency in a feature space may be assessed by comparing the calculated proficiency metric for a feature space to a threshold, target range, or other target value.

If the ML model's proficiency metric for a feature space is below the threshold, target range, or other target value, additional training datasets 414 may be generated and/or obtained targeting the feature space to increase the ML model's proficiency metric for the feature space above the threshold, target range, or other target value. Additional training datasets may be generated by another ML model (e.g., a large language model (LLM) based on a prompt), based on historical data, based on publicly available data (e.g., pulled from the internet), manually created, or some combination thereof. For example, in some embodiments, training data sets may include labels of ground truth categories. At block 416, the training datasets 414 may be used to train the ML model.

In the runtime framework 402, an input 302 is received and a use case workflow 418 is initiated. As previously described, the input 302 may include a prompt and one or more pieces of accompanying data (e.g., a dataset, a document, an image, an audio file, etc.). At block 420, a feature space membership analysis is performed on the input. For example, similar to as described with regard to the operations by the ML model to generate outputs in the failure analysis performed in block 408, the feature space membership analysis may include assigning a point for the input along one or more dimensions and determining, based on the points for the input along one or more dimensions, one or more feature spaces to which the input 302 belongs.

After the one or more feature spaces to which the input 302 belongs have been identified, the ML model proficiency metric for the identified feature spaces may be calculated or referenced to determine whether or not the ML model proficiency metric for the identified feature spaces is greater than or equal to one or more respective thresholds, target ranges, or other target values. If the ML model proficiency metric for the identified feature spaces is greater than or equal to one or more respective thresholds, target ranges, or other target values, the input 302 may be provided to the ML model, the ML model generates an output 304, and the output 304 is transmitted to the requesting client device. However, if the ML model proficiency metric for the identified feature spaces is less than the one or more respective thresholds, target ranges, or other target values, the input 302 may be deflected to an alternative resource and an output generated via the alternative resource. In such embodiments, the alternative resource may be another ML model, an algorithm, an agent profile, a document or webpage (e.g., a troubleshooting guide, an article about a particular topic, etc.) and so forth.

Alternatively, in some embodiments, if the ML model proficiency metric for the identified feature spaces is less than the one or more respective thresholds, target ranges, or other target values, the feature space membership analysis 420 may determine whether the input can be transformed to a different feature space for which the ML model proficiency metric is greater than or equal to one or more respective thresholds, target ranges, or other target values. If so, the input may be transformed (e.g., the text of the input modified) such that the transformed input belongs to the different feature space for which the ML model proficiency metric is greater than or equal to one or more respective thresholds, target ranges, or other target values, but maintains the same or similar semantic value. For example, an input may be transformed by removing email headers from the inputs, by translating the input to a different language, and so forth. The transformed input may then be transmitted to the ML model 422, an output 304 generated by the ML model, and the output provided to the requesting client device.

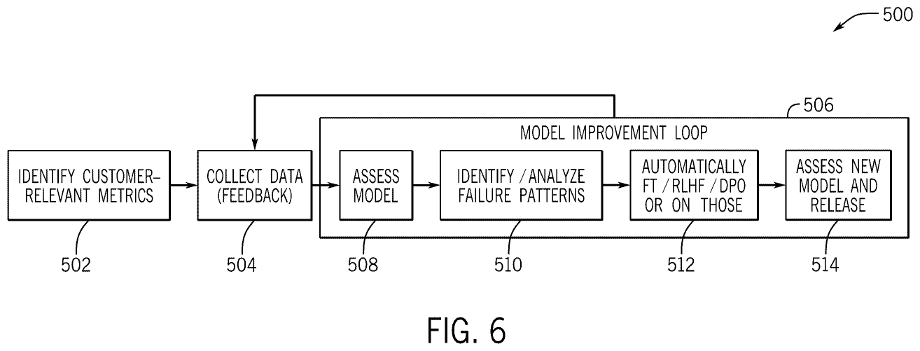

FIG. 6 illustrates a framework 500 for improving ML model performance. At 502, customer-relevant metrics for the ML model are identified. The identified metrics may be based on preferences or feedback provided by one or more users, based on the purpose the ML model provides (e.g., IT assistance, procurement, human resources (HR) policy guidance, benefit guidance, customer assistance, travel planning, troubleshooting, etc.) to a customer, the customer's industry, help ticket data, customer service data, and so forth. For example, the drawbacks of the ML model producing an incorrect output in one area (e.g., legal department) may be higher than another department (e.g., procurement of office supplies). Accordingly, identifying relevant metrics for each customer may be helpful in achieving the best ML model performance for each customer. At block 504, feedback data is collected. As previously described, feedback data may be generated by users in response to outputs generated by the ML model (e.g., “this output is exactly what I was looking for”, “this output was not correct”, “this output was not relevant”, “this output was too long”, etc.) In some embodiments, the feedback data may merely provide feedback on the output (e.g., correct, incorrect, relevant, not relevant, too long, too short, etc.), whereas in other embodiments, the feedback data may identify a better output or one or more qualities of a better output. The feedback data may include data generated by agents reviewing outputs generated by the ML model. In some embodiments, as previously described, data from system logs may be analyzed to determine whether or not outputs were satisfactory. In further embodiments, feedback data may be generated by an additional ML model (e.g., an evaluation model) configured to assess outputs generated by the ML model (e.g., the inference model).

At 508, the model is assessed. As previously described with regard to FIG. 5, the model assessment may include determining one or more respective performance metrics for a plurality of outputs generated by the ML model. In some embodiments, multiple metrics (e.g., accuracy and coverage) may be combined or plotted against one another to assess the output relative to a combined metric. At 510, outputs having performance metric values below a threshold are analyzed to identify failure patterns. For example, outputs having performance metric values below a threshold may be analyzed to identify characteristics multiple outputs have in common that may be correlated with metric values being below the threshold. Specifically, outputs may be grouped based on a similarity criterion indicative of outputs having one or more characteristics in common. For example, an operation by the ML model to generate an output in response to an input may be assigned respective points in one or more dimensions that correspond to characteristics or properties of the operation by the ML model to generate the output in response to the input. Operations by the ML model to generate the outputs based on the respective inputs may be grouped into clusters with shared or similar points in a common dimension that fall into feature spaces. The feature space proficiency metric of the ML model may be determined using a statistical operation (e.g., average) of the performance metrics of the operations by the ML model to generate the outputs based on the respective inputs that fall into the feature space. Accordingly, feature spaces can be identified in which the ML model performs above target, at target, and/or below target.

At block 512, the model may be automatically improved in the feature spaces for which the proficiency of the ML model is below a threshold. Improvement may be achieved via fine tuning (FT), reinforcement learning based on human feedback (RLHF), direct preference optimization (DPO), other techniques, or some combination thereof. Improvement may utilize training data generated by another ML model (e.g., such as a LLM), data generated by one or more humans, publicly available data, historical data, and so forth. After the model has gone through improvement, at block 514, the model may be assessed, for example using available test data, and released for use.

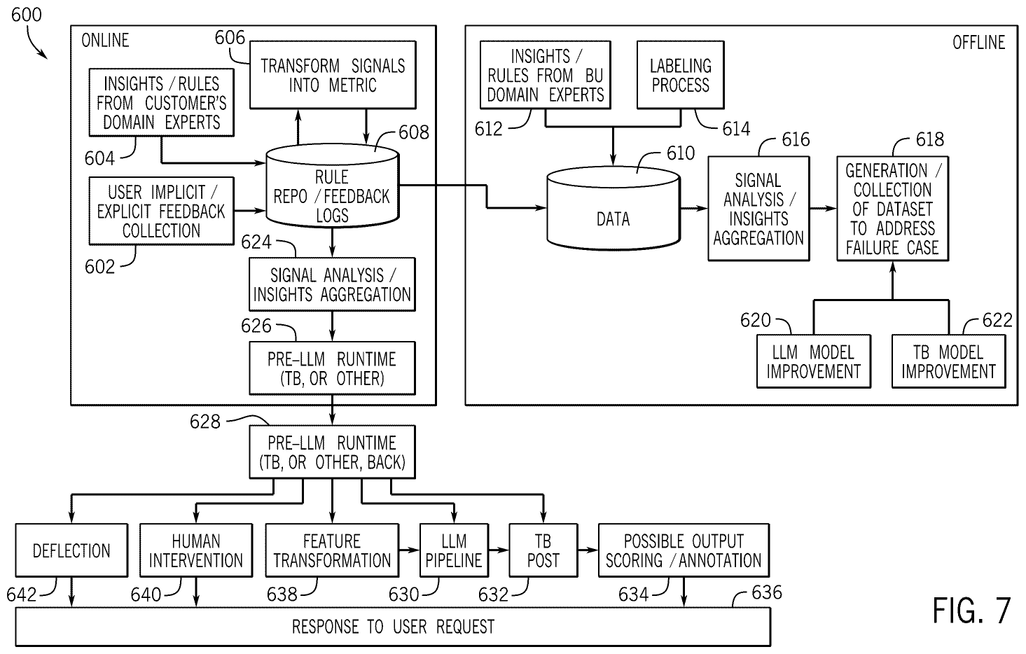

FIG. 7 illustrates a framework for assessing and improving a ML model. As previously described, feedback data, which may include user feedback 602 and/or feedback from one or more agents or domain experts 604 may be received and stored in a database 608, which may also store log data (e.g., data associated with operations by a ML model to generate an output in response to receiving an input, and various activities surrounding the input and/or output) and a rule repository. At block 606, data stored in the database 608 may be analyzed to transform signals into metrics for each of the operations by the ML model to generate the outputs in response to receiving the inputs. The one or more metrics generated for each operation may characterize the output and/or the operation (e.g., was the output accurate? Was the output relevant?).

Data from the database 608 may periodically be duplicated (e.g., via one or more telemetry tools) to an offline database 610. At 612, insights and/or rules generated by one or more business unit expert profiles may be provided to the offline database 610. Similarly, at 614, a labeling process may be performed. The labeling process may be autonomous (e.g., by applying a labeling algorithm or model to data), semi-autonomous (e.g., manually labeled examples are provided to the labeling algorithm or model and the algorithm or model uses the exampled to label remaining data), or manual (e.g., labels of all of the data in a dataset are provided, for example, by a label profile).

At 616, a signal analysis and/or insights aggregation may be performed. As previously described, the signal analysis and/or insights aggregation may include identifying operations by the ML model to generate an output in response to receiving an input that have one or more characteristics or properties in common and forming clusters of similar operations by the ML model to generate an output in response to receiving an input that fall within a feature space. For example, each operation by the ML model to generate an output in response to receiving an input may be assigned points along one or more dimensions that represent characteristics or properties of the input, the output, and/or the operation. Operations having the same or similar points in the same direction may satisfy a similarity criterion, resulting in the operations being grouped into the same cluster and defining a feature space. A feature space proficiency metric may be determined for the ML model in a specific feature space by performing a statistical operation (e.g., average) of the performance metrics of the operations within a feature space. Accordingly, by determining the feature space proficiency metrics for multiple feature spaces and comparing the feature space proficiency metrics to target thresholds, feature spaces can be identified in which the ML model is performing above target, at target, and/or below target.

At 618 training datasets can be generated using collected data and/or generated data (e.g., data generated by an LLM and/or manually generated data) that targets one or more feature spaces in which the feature space proficiency metric of the ML model is below the target threshold. Accordingly, at block 620, the ML model (e.g., the inference model) may be trained using the generated training datasets to increase the feature space proficiency metric of the ML model in the feature space. In some embodiments, the evaluation model may also be trained on generated training datasets, which may be the same training datasets used to train the ML model (e.g., the inference model) or different from the training datasets used to train the ML model (e.g., the inference model).

At 624, a signal analysis and/or insights aggregation may be performed on the data stored in the database 608. As with the signal analysis and/or insights aggregation described with regard to block 616, the signal analysis and/or insights aggregation may include identifying operations by the ML model to generate an output in response to receiving an input that have one or more characteristics or properties in common and forming clusters of similar operations by the ML model that fall within a feature space. Each operation by the ML model to generate an output in response to receiving an input may be assigned points along one or more dimensions that represent characteristics or properties of the input, the output, and/or the operation. Operations having the same or similar points in the same direction may satisfy a similarity criterion, such that operations are grouped into the same cluster. A feature space (e.g., a subset of the hyperspace identified by the dimensions of interest) proficiency metric may be determined for the ML model in a specific feature space based on the performance metrics of the operations within the feature space. By comparing the feature space proficiency metrics for multiple feature spaces to target thresholds, feature spaces can be identified in which the ML model is performing above target, at target, and/or below target.

At 626 and 628, the evaluation model may receive inputs intended for the ML model. The evaluation model may be configured to analyze received inputs by placing the input itself, or an anticipated operation to generate an output based on the operation, or both, into a feature space. For example, the evaluation model may be configured to assess one or more characteristics of the input and/or the anticipated operation to generate an output based on the input. The evaluation model may be configured to assign points in one or more dimensions for the input and/or the anticipated operation to generate an output based on the input in one or more feature spaces. The evaluation model may determine and/or reference respective feature space proficiency metrics for the ML model in the identified one or more feature spaces for the input and/or the anticipated operation to generate an output based on the input. If the feature space proficiency metrics for the ML model in the identified one or more feature spaces are equal to or above a target threshold, the evaluation model may provide the input to the LLM pipeline 630 such that the ML model (e.g., the inference model) generates an output in response to receiving the input. At block 632, the output generated by the ML model (e.g., the inference model) may be provided to the evaluation model for assessment. For example, at block 634, the evaluation model may score (e.g., calculate a performance metric) and/or annotate the output generated by the ML model (e.g., the inference model). If the evaluation model determines that the output is acceptable (e.g., the score or performance metric for the output exceeds a threshold value), the output may be transmitted to the requesting client device (block 636).

However, if the feature space proficiency metrics for the ML model 628 in the identified one or more feature spaces are below the target threshold, the evaluation model may determine whether the input can be transformed to another feature space for which the feature space proficiency metrics for the ML model are equal to or greater than the target threshold while maintaining the semantic meaning of the input. If so, the evaluation model may transform the input 638 and provide the transformed input to the LLM pipeline 630. Transforming the input may include, for example, translating the input to another language, removing words from the input, adding words to the input, changing the grammar of the input, etc. as long as the semantic value of the transformed input is within a threshold semantic distance (e.g., based on a semantic vector), of the original input.

In some embodiments, an agent profile may monitor the ML model and intervene (block 640) to direct the input to a specific resource to generate the output, flag the input as against one or more guidelines and decline to generate an output for the input, provide an output for the input, flag the input for moderation, and so forth. Accordingly, when human intervention occurs, an output or other message may or may not be transmitted to the requesting client device.

If the feature space proficiency metrics for the ML model in the identified one or more feature spaces are below the target threshold and the input cannot be transformed to a feature space for which the proficiency metrics for the ML model are equal to or greater than the target threshold, the evaluation model may, at block 642, deflect the input to an alternative resource configured to generate an output based on the input. The alternative resource may include, for example, another ML model, a client device associated with an agent profile, an algorithm, a database or other repository of relevant data, and so forth.

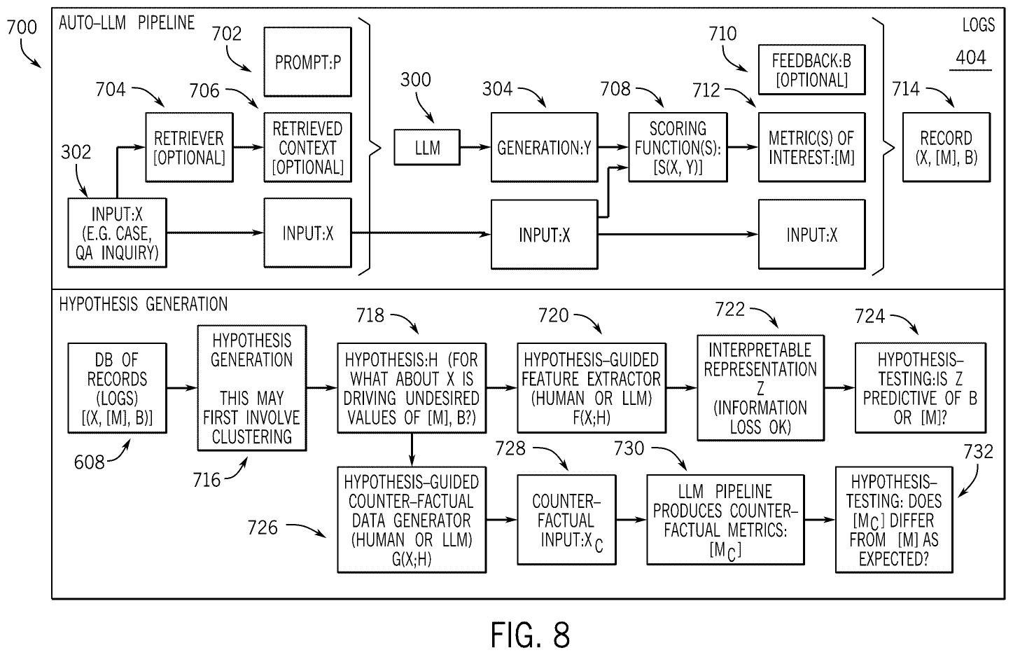

FIG. 8 is a schematic illustrating an autonomous LLM pipeline 700. As previously described, an input 302 is received. The input 302 includes a prompt 702 requesting generation of an output 304. In some embodiments, the input 302 may include one or more pieces of accompanying data. For example, the one or more pieces of accompanying data may include, a dataset, a document, an image, an audio file, etc. In some embodiments, the accompanying data may also include one or more references to data, such as an identifier, a tag, a file name, and so forth. In such embodiments, a retriever 704 may be used to retrieve data or other context 706, which may be provided to the LLM 300, along with the prompt 702 and the input data 302. The LLM 300 generates an output 304 based on the input 302, the prompt 702, and/or the retrieved data 706.

At block 708, one or more scoring functions may be applied to the input 302, the output 304, or both, to determine one or more metrics 712. The scoring functions may be applied to generate one or more metrics assessing the credibility, accuracy, relevance, etc. of the input 302, the output 304, or both. In some embodiments, the scoring functions may also assign the input 302, the output 304, or both points along one or more dimensions to represent various characteristics and/or properties of the input 302 and/or the output 304.

In some embodiments, feedback data 710 may be received, from a user profile, an agent profile, or both assessing the output 304. The feedback data 710 may be combined with the output 304, the input 302, and the metrics of interest 712, and a record 714 created to be stored in a log 404, which may be stored in a database 608.

The database 608 of records 714 may then be accessed and, at block 716, one or more hypotheses 718 generated. Each of the one or more hypotheses provides an explanation as to what characteristics of the input 302 result in metrics 712 below some threshold value and/or negative feedback data 710. In some embodiments, the hypothesis generation may involve clustering. For example, as previously described, outputs 304 may be assigned points along one or more dimensions to represent various characteristics and/or properties of the output 304 and/or the input 302. Multiple outputs 304 having the same or similar values in a common dimension may satisfy a similarly criterion, such that the multiple outputs 304 are combined into a cluster that falls into a feature space. For example, outputs 304 that share the same or similar values in the common dimension fall into the feature space.

For each hypothesis 718, a hypothesis-guided feature extractor 720 may be utilized to extract various features (e.g., points on one or more dimensions) associated with the hypothesis, resulting in an interpretable representation 722 of the hypothesis (e.g., the features extracted at 720 that describe or otherwise represent the hypothesis). The hypothesis-guided feature extractor 720 may be based on a ML model or an algorithm, or based on inputs received from a client device (e.g., via a user or agent profile). At block 724, hypothesis testing may be performed to determine whether the interpretable representation 722 of the hypothesis of is predictive of metrics 712 below some threshold value and/or negative feedback data 710. For example, the database of records 608 may be parsed to identify whether one or more records 714 have the extracted features of the interpretable representation 722 of the hypothesis and then identifying if those records include metrics 712 below some threshold value and/or negative feedback data 710.

At block 726, a hypothesis-guided counterfactual data generator, which may also be based on a ML model or an algorithm, or based on inputs received from a client device (e.g., via a user or agent profile), may be utilized to determine counterfactual inputs 728 that, when provided to the LLM 300, results in a counterfactual output that supports or opposes the hypothesis. At block 730, counterfactual metrics are determined for the counterfactual output generated in response to the counterfactual input. At 732, hypothesis testing may be performed to determine whether the counterfactual metrics for the counterfactual output generated in response to the counterfactual input differ from the metrics 712 for the outputs 304 generated in response to the inputs 302, as expected.

Based on the hypothesis testing in block 724 and 732, training datasets may be generated in response to hypotheses determined to be true to improve the model and address the hypotheses. The LLM 300 may then be trained on the generated training data to improve the LLM's 300 performance in one or more feature spaces.

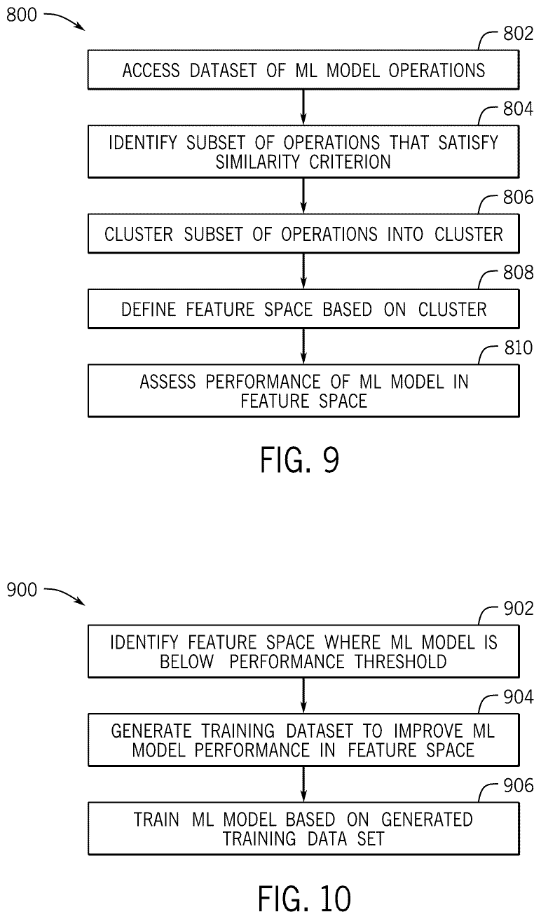

FIG. 9 is a flow chart of a process 800 for assessing the performance of a ML model. At block 802 a dataset of ML model operations is received or accessed. The data may include data associated with operations of the ML model to generate outputs in response to receiving respective inputs. In some embodiments, the dataset may include respective performance metrics characterizing the outputs generated by the ML model. In other embodiments, the data may include log data associated with actions of the ML model, the network, and/or computing devices associated with the network, etc., and/or feedback data with feedback on one out more outputs of the ML model generated by one or more user profiles, one or more agent profiles, another ML model (e.g., an evaluation model), and so forth. Accordingly, in some embodiments, the process 800 may include using the dataset to calculate metrics for one or more outputs generated by the ML model. For example, the process 800 may assess the accuracy of the output, the coverage (e.g., relevance) of the output, whether the output was helpful, whether the output was too short or too long, and so forth.

In some embodiments, multiple metrics may be combined into one or more combined metrics or plotted against one another. For example, a credibility interval may define a range of acceptable outputs based on the accuracy and the coverage metrics of an output. In such embodiments, the credibility interval may define a box on a plot in which the accuracy metric is plotted along a first axis and the coverage metric is plotted along a second axis. If the point on the plot defined by the accuracy metric and the coverage metric falls within the box defined by the credibility interval, the output is determined to be desirable. If the point on the plot defined by the accuracy metric and the coverage metric falls outside the box defined by the credibility interval, the output is determined to be not desirable.

At block 804, the process 800 identifies a subset of operations that satisfy a similarity criterion. Specifically, a subset of the operations may be identified based on a similarity criterion indicative of operations having one or more characteristics in common. For example, an operation by the ML model to generate an output in response to an input may be assigned respective points in one or more dimensions that correspond to characteristics or properties of the operation by the ML model to generate the output in response to the input. Operations having the same or similar points (e.g., points within some threshold distance) in the same dimension may satisfy a similarity criterion.

At block 806, the operations in the subset of operations are clustered together to form a cluster. At block 808, a feature space is defined based on the cluster. For example, a feature space may be defined by operations that have the same or similar points in one or more dimensions such that a first operation having a point in one or more dimensions that matches a cluster definition (e.g., points having a value or within a range of values for one or more dimensions) falls within the feature space and a second operation that does not have a point in one or more dimensions that matches the cluster definition does not fall within the feature space.

At block 810, the process 800 assesses the performance of the ML model in the feature space. For example, a feature space proficiency metric for the ML model in the feature space may be determined by performing a statistical operation (e.g., average, adjusted average, or some other statistical calculation) on the metrics for the operations that fall within the feature space (e.g., the operations in the cluster). In some embodiments, the statistical operation may be performed on a subset of the operations that fall within the feature space. For example, to assess the performance of the ML model before and after a training operation, a first feature space proficiency metric may be calculated for operations performed before a training operation, a second feature space proficiency metric may be calculated for operations performed after the training operation, and the first and second feature space proficiency metrics compared to one another. In other embodiments, the feature space proficiency metric for operations performed during some time period may be of particular interest. Accordingly, the statistical operation may be performed only on operations that fall within the time period.

Being able to identify feature spaces in which a ML model performs below a target level is useful in the longer term for understanding where to make improvements and in the shorter term for understanding what operations the ML model should be allowed to perform and what operations should be deflected to alternative resources. Specifically, as described below, understanding the feature spaces in which performance of the ML model is deficient allows resources to be efficiently allocated to maximize improvement in the identified feature spaces by generating and/or collecting datasets that target one or more feature spaces for which the ML model is deficient. Accordingly, characteristics of the identified feature spaces may provide guidance on characteristics of training data that will be most helpful in improving performance of the ML model through training. Further, understanding the feature spaces in which performance of the ML model is deficient allows inputs requesting operations in the identified feature spaces to be deflected to alternative resources to perform the operations, resulting in improved performance of the system (e.g., more desirable outputs provided to requesting client devices) and improved confidence in the ML model.

FIG. 10 is a flow chart of a process 900 for improving the ML model. At block 902, a feature space is identified in which the ML model is performing below a performance threshold. For example, feature space proficiency metrics for the ML model in different feature spaces may be compared to feature space proficiency metric threshold values. The feature space proficiency metric thresholds may be set uniformly such that all feature spaces have the same feature space proficiency metric threshold, or uniquely set such that the feature space proficiency metric threshold may vary from feature space to feature space.

At block 904, a training dataset is generated such that, when the ML model is trained on the training dataset, the feature space proficiency metric for the ML model in the identified feature space improves, and in some cases cause the feature space proficiency metric for the ML model in the feature space after training to be above the feature space proficiency metric threshold. The training dataset may be generated by another ML model, such as an LLM. For example, a prompt may be provided to an LLM to generate a training dataset having the characteristics that define the feature space (e.g., points or ranges of points in one or more dimensions). In other embodiments, the training dataset may be based on data collected from some publicly available source, such as the internet, a database, published media, etc. In further embodiments, the training dataset may be manually created via one or more user profiles or agent profiles. The training dataset may also include a combination of data generated by a ML model, collected data, and manually created data. At block 906, the ML model is trained on the training dataset.

Being able to identify feature spaces in which a ML model performs below a target level allows for training data to be narrowly targeted to identified feature spaces. Whereas previously training data of broad scope was collected and used to train ML models in hopes that the training data would improve performance of the ML model across the board, using the disclosed techniques to develop training data that is specifically targeted to the deficiencies of the ML model helps to efficiently utilize available resources to maximize improvement of the performance of the ML model in feature spaces for which improvement is needed most. These techniques result in ML models that generate more accurate and relevant outputs and improve at faster rates than existing ML models.

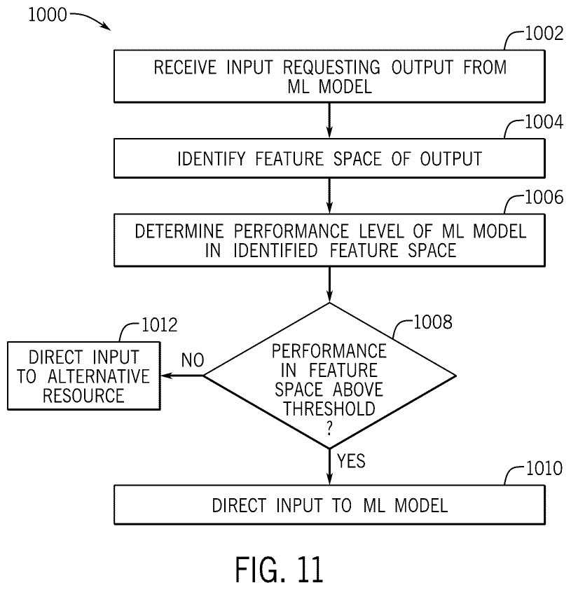

FIG. 11 is a flow chart of a process 1000 for utilizing a ML model in runtime. At block 1002, an input is received requesting an output from the ML model. The input may include a prompt and, in some cases, one or more pieces of accompanying data (e.g., a dataset, a document, an image, an audio file, etc.). At block 1004, the process 1000 determines the feature space of the output. For example, the input may be analyzed by the input itself, or an anticipated operation to generate an output based on the operation, or both, into a feature space. For example, the process 1000 may assess one or more characteristics of the input and/or the anticipated operation to generate an output based on the input, and assign points in one or more dimensions for the input and/or the anticipated operation to generate an output based on the input to locate the input and/or the anticipated operation to generate an output based on the input in one or more feature spaces.

At block 1006, the process 1000 may determine the performance level of the ML model in the one or more identified feature spaces. For example, the process 1000 may determine and/or reference respective feature space proficiency metrics for the ML model in the identified one or more feature spaces for the input and/or the anticipated operation to generate an output based on the input.

At block 1008, the process 1000 determines whether the performance of the ML model in the one or more identified feature spaces is above some threshold value. For example, the feature space proficiency metrics for the ML model in the identified one or more feature spaces may be compared to one or more feature space proficiency metric thresholds. If the feature space proficiency metrics for the ML model in the identified one or more feature spaces are equal to or above a target threshold, the process 1000, at block 1010, provides the input to the ML model such that the ML model generates an output in response to the input, which may be provided to the requesting client device. As previously described, in some embodiments, the output may be reviewed and/or assessed before transmission to the requesting client device.

Though not shown in FIG. 11, in some embodiments, if the feature space proficiency metrics for the ML model in the identified one or more feature spaces are below the target threshold, the process 1000 may determine whether the input can be transformed to another feature space for which the feature space proficiency metrics for the ML model are equal to or greater than the target threshold while maintaining the semantic meaning of the input. If so, the input may be transformed (e.g., translated to another language, removing words from the input, adding words to the input, changing the grammar of the input, etc. as long as the semantic value of the transformed input is within a threshold semantic distance (e.g., based on a semantic vector), of the original input) and provided to the ML model (block 1010).

If, at block 1008, the feature space proficiency metrics for the ML model in the identified one or more feature spaces are below the target threshold and the input cannot be transformed to a feature space for which the proficiency metrics for the ML model are equal to or greater than the target threshold, the process 1000 proceeds to block 1012 and deflects the input to an alternative resource (e.g., another ML model, a client device associated with an agent profile, an algorithm, a database or other repository of relevant data, etc.) configured to generate an output based on the input.

Previously, inputs were provided to ML models without consideration of whether the ML model was capable of generating an accurate and relevant output in response to the input. By analyzing received inputs to determine whether the ML model is capable of generating a sufficiently accurate and relevant response, and deflecting inputs requesting operations for which the ML model is not well-suited to alternative resources, overall performance in generating outputs in response to inputs is improved (e.g., outputs are more accurate and more relevant to inputs). Accordingly, the disclosed techniques result in better performing ML models that improve at a faster rate than existing ML models, resulting in improved confidence in ML models and faster adoption of ML models.

The presently disclosed techniques may be used for analyzing and improving performance of machine learning models. System logs, feedback data (e.g., generated by users or agents in response to an output of the ML model), and other data may be used to calculate one or more metrics for each output generated. For example, for each output generated, the metrics may include determining the accuracy of the output and the coverage of the output. In some embodiments, the accuracy and coverage of a particular output may be combined and compared relative to a credibility interval.

A failure analysis is performed for the outputs that are outside of the credibility interval or otherwise have accuracy and/or coverage metrics below threshold values. The failure analysis may include clustering input/output exchanges based on shared characteristics. For example, each input/output exchange may be assigned a point in one or more dimensions that correspond to characteristics or properties of the input/output exchange. Dimensions may include, for example, format of input, language of input and/or output, input structure, user sentiment, subject matter, task to be performed, and so forth. Dimensions may be continuous or discrete such that a point within a dimension may be a point along a continuous spectrum or one of multiple discrete or quantized options. Input/output exchanges with shared or similar points in a common dimension may be grouped into clusters that fall into feature spaces. How well a ML model performs within a feature space can be determined based on the metrics for the input/output exchanges that fall within the feature space. Accordingly, the feature spaces in which a ML model performs below a target performance level can be identified and new training datasets generated to improve a ML model's performance in those feature spaces. Being able to identify feature spaces in which a ML model performs below a target level allows for training data to be narrowly targeted to deficient feature spaces such that resources utilized to improve the ML model are efficiently utilized to improve the performance of the ML model in feature spaces for which improvement is needed most. Previously, training data of broad scope was collected and used to train ML models in hopes that the training data would improve performance of the ML model across the board.

In run time, an input may be received requesting an output from a ML model. The input may be analyzed by performing a feature space membership analysis to determine one or more feature spaces in which the input and/or the requested output fall. The feature space membership analysis may include, for example, identifying a respective point for the input or output within one or more dimensions. If the input or output falls within a feature space for which the ML model performs above or equal to a threshold, the input may be provided to the ML model and an output generated by the ML model. If the input or output falls within a feature space for which the ML model performs below a threshold, the input may be deflected away from the ML model (e.g., to an alternative ML model or a non-ML resource for generating the output). Alternatively, if the input falls within a feature space for which the ML model performs below a threshold, the input may be transformed to a transformed input within a feature space for which the ML model performs above a threshold. The transformed input may then be provided to the ML model and an output generated by the ML model. Previously, inputs were provided to ML models without consideration of whether the input requested that the ML model perform an operation it was not well suited for. By screening inputs received and deflecting inputs requesting operations for which the ML model is not well-suited to alternative resources, overall performance in generating outputs in response to inputs is improved (e.g., outputs are more accurate and more relevant to inputs). The disclosed techniques result in better performing ML models, which improve at a faster rate than was previously possible, resulting in improved confidence in ML models and faster adoption of ML models.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

1. A method comprising:
receiving an input requesting an output from a machine learning (ML) model;
identifying a feature space for the output, wherein the feature space is associated with one or more characteristics shared by the output and one or more additional outputs of the ML model;
determining a feature space proficiency metric for the ML model in the identified feature space; and
in response to the feature space proficiency metric for the ML model in the identified feature space satisfying an error threshold, providing the input to an alternative resource configured to generate the output.

2. The method of claim 1, wherein identifying the feature space for the output comprises:
assigning a point for the output along a dimension; and
identifying the feature space based on the point along the dimension.

3. The method of claim 1, comprising:
identifying an additional feature space for the output, wherein the additional feature space is associated with an additional characteristic of the one or more characteristics shared by the output and one or more further outputs of the ML model; and
determining an additional feature space proficiency metric for the ML model in the identified additional feature space.

4. The method of claim 1, wherein determining the feature space proficiency metric for the ML model in the identified feature space is based on evaluations of the one or more additional outputs of the ML model in the feature space.

5. The method of claim 1, comprising determining that the input cannot be transformed to result in the output belonging to a different feature space having a respective proficiency metric that satisfies the error threshold.

6. The method of claim 1, wherein the alternative resource comprises an additional ML model.

7. The method of claim 6, wherein the additional ML model is configured to generate the output based on the input.

8. The method of claim 1, wherein the alternative resource comprises a client device.

9. A system, comprising:
processing circuitry; and
a memory, accessible by the processing circuitry, and storing instructions that, when executed by the processing circuitry, cause the processing circuitry to execute a client instance, wherein the client instance is configured to perform operations comprising:
receiving an input requesting an output from a machine learning (ML) model;
identifying a feature space for the output, wherein the feature space is associated with one or more characteristics shared by the output and one or more additional outputs of the ML model;
determining a feature space proficiency metric for the ML model in the identified feature space; and
in response to the feature space proficiency metric for the ML model in the identified feature space satisfying an error threshold, providing the input to an alternative resource configured to generate the output.

10. The system of claim 9, wherein identifying the feature space for the output comprises:
assigning a point for the output along a dimension; and
identifying the feature space based on the point along the dimension.

11. The system of claim 9, wherein the operations comprise:
identifying an additional feature space for the output, wherein the additional feature space is associated with an additional characteristic of the one or more characteristics shared by the output and one or more further outputs of the ML model; and
determining an additional feature space proficiency metric for the ML model in the identified additional feature space.

12. The system of claim 9, wherein determining the feature space proficiency metric for the ML model in the identified feature space is based on evaluations of the one or more additional outputs of the ML model in the feature space.

13. The system of claim 9, wherein the operations comprise determining that the input cannot be transformed to result in the output belonging to a different feature space having a respective proficiency metric that satisfies the error threshold.

14. A non-transitory, computer readable medium comprising instructions that, when executed by processing circuitry, cause the processing circuitry to perform operations comprising:
receiving an input requesting an output from a machine learning (ML) model;
identifying a feature space for the output, wherein the feature space is associated with one or more characteristics shared by the output and one or more additional outputs of the ML model;
determining a feature space proficiency metric for the ML model in the identified feature space; and
in response to the feature space proficiency metric for the ML model in the identified feature space satisfying an error threshold, providing the input to an alternative resource configured to generate the output.

15. The computer readable medium of claim 14, wherein the alternative resource comprises an agent.

16. The computer readable medium of claim 14, wherein the alternative resource comprises a webpage.

17. The computer readable medium of claim 14, wherein the alternative resource comprises a troubleshooting guide.

18. The computer readable medium of claim 14, wherein the alternative resource comprises an additional ML model.

19. The computer readable medium of claim 18, wherein the additional ML model is configured to generate the output based on the input.

20. The computer readable medium of claim 14, wherein the alternative resource comprises a client device.
